(19) United States
(12) Patent Application Publication
(10) Pub. No.: US 2016/0066597 A1
(43) Pub. Date: Mar. 10, 2016

(54) STICK INSERTER WITH ELECTROMAGNETIC DRIVE SYSTEM

(71) Applicant: TETRA LAVAL HOLDING & FINANCE S.A., Pully (CH)

(72) Inventors: Flemming KIRKEBY, Hammel (DK); Lars Greve Brix CHRISTIANSEN, Hojbjerg (DK)

(73) Assignee: TETRA LAVAL HOLDINGS & FINANCE S.A., Pully, OT (CH)

(21) Appl. No.: 14/782,446

(22) PCT Filed: Apr. 2, 2014
(86) PCT No.: PCT/EP2014/056613

§ 371 Date: Oct. 5, 2015

(30) Foreign Application Priority Data
Apr. 5, 2013 (DK) PA 2013 70187

(51) Int. Cl. A23G 9/26

(52) U.S. Cl. CPC A23G 9/265

(57) ABSTRACT

A stick inserter for inserting ice cream sticks into frozen ice cream mass is disclosed, the stick inserter comprising a pusher guide arranged to hold a pile of ice cream sticks and guide the motion of the ice cream sticks when they move from the pusher guide into the frozen ice cream mass, a pusher plate arranged to reciprocate so that, when the pusher plate moves in a first direction, it pushes an ice cream stick of the pile out of the pusher guide, and when the pusher plate moves in the opposite, second direction, the next ice cream stick in the pile may move into position for being pushed out of the pusher guide, and a linear actuator driving the reciprocating motion of the pusher plate, wherein the linear actuator is arranged to be driven by an alternating electromagnetic field.

The present invention relates to a stick inserter for inserting ice cream sticks into frozen ice cream mass, a use of such a stick inserter, a method for inserting ice cream sticks into frozen ice cream mass and methods for upgrading an ice cream production apparatus.

### BACKGROUND OF THE INVENTION

It is known in the art to use stick inserters driven by pneumatic linear actuators for inserting ice cream sticks into a partly frozen ice cream mass. In most of such cases, the ice cream sticks are inserted into an extruded ice cream mass but it is also known to use such stick inserters in relation to apparatuses producing ice cream products by moulding.

Some known problems are related to the use of such stick inserters, namely a relatively large energy consumption, a relatively large level of noise, a limited expected lifetime of the actuators (between 2 weeks and 6 months, typically around 3 months) and a limited speed of operation of the stick inserter (typically around 150 sticks per minute, the maximum speed not exceeding 200 sticks per minute).

### BRIEF DESCRIPTION OF THE INVENTION

It is an object of the present invention to provide a stick inserter a method, which overcome, or at least mitigate, one or more of the above-identified problems.

In a first aspect of the present invention, it relates to a stick inserter for inserting ice cream sticks into frozen ice cream mass, said stick inserter comprising a pusher guide arranged to hold a pile of ice cream sticks and guide the motion of the ice cream sticks when they move from the pusher guide into the frozen ice cream mass, a pusher plate arranged to reciprocate so that, when the pusher plate moves in a first direction, it pushes an ice cream stick of the pile out of the pusher guide, and when the pusher plate moves in the opposite, second direction, the next ice cream stick in the pile may move into position for being pushed out of the pusher guide, and a linear actuator driving the reciprocating motion of the pusher plate, wherein the linear actuator is arranged to be driven by means of an alternating electromagnetic field.

Driving the linear actuator by means of an alternating electromagnetic field allows for a faster and less noisy operation of the linear actuator than for similar pneumatic systems known in the art. The speed of the stick inserter can be increased by at least a factor of 2 or 3 compared to pneumatic actuators and the noise level is expected to be reduced by approximately 10 dB.

Furthermore, the expected lifetime of such actuators is significantly longer than the one of pneumatic actuators and the energy consumption is significantly (up to about 90%) lower than that of pneumatic actuators.

The motion of the linear actuator may be controlled using a servomechanism.

Using a servomechanism for controlling the motion of the linear actuator ensures a very accurate and reliable control thereof.

The linear actuator may be arranged to be cooled by a cooling block arranged around the linear actuator.

Arranging a cooling block around the linear actuator ensures a very efficient cooling thereof.

The linear actuator may be arranged to reciprocate between 200 and 600 times per minute, preferably between 300 and 400 times per minute.

Running the linear actuator at reciprocation frequencies within these ranges allows for a faster operation than known from systems in the art, still allowing the other parts of the machinery, of which the stick inserter is a part, to be able to keep up with the increased speed of operation.

The ice cream stick pushed out of the pile by the pusher plate may be a lowermost ice cream stick in the pile.

For practical reasons, it is advantageous in many configurations of the stick inserter that the ice cream stick pushed out of the pile by the pusher plate is the lowermost stick in the pile.

The pile of ice cream sticks may be arranged so that, when the pusher plate moves in the second direction, the next ice cream stick in the pile is caused to move into position for being pushed out of the pusher guide by gravity.

It is advantageous to arrange the pile of ice cream sticks in such a way that gravity causes the next stick to move into position for being inserted into the ice cream mass. In this way, no additional equipment is necessary for making the next stick ready to be inserted.

The stick inserter may be arranged to be retrofitted in existing ice cream production apparatuses.

By retrofitting the stick inserter according to the invention into existing ice cream production apparatuses, the advantages of the stick inserter can be obtained without having to invest very large sums in new complete production apparatuses.

In another aspect of the invention, it relates to the use of a stick inserter as described above for inserting ice cream sticks into an ice cream mass being extruded from an ice cream production apparatus.

The temperature of the ice cream mass may be between −10° C. and −1° C., preferably between −6° C. and −3° C.

Using the stick inserter for inserting ice cream sticks into an extruded ice cream mass, especially an into ice cream mass with a temperature within these ranges, allows for a very efficient insertion of the ice cream sticks.

In yet another aspect of the invention, it provides a use of a stick inserter as described above for inserting ice cream sticks into an ice cream mass in a mould.

In other types of ice cream production apparatuses, the stick inserter may advantageously be arranged to insert sticks into ice cream mass being moulded. In this case, the operation of a plurality of stick inserters may advantageously be coordinated, so that a plurality of ice cream sticks are inserted simultaneously, depending on the physical configuration of the mould table of the apparatus.

In still another aspect of the invention, a method is provided for inserting an ice cream stick into frozen ice cream mass, said method comprising the steps of moving a pusher plate from a loading position to an inserting position pushing the ice cream stick along a pusher guide into the ice cream mass, and moving the pusher plate from the inserting position back to the loading position allowing another ice cream stick to be put in position for being inserted into the ice cream mass, wherein the pusher plate is reciprocated by a linear actuator arranged to be driven by means of an alternating electromagnetic field.

In a further aspect of the invention, a method is provided for upgrading an ice cream production apparatus, which method comprises the step of retrofitting a stick inserter as described above in the ice cream production apparatus.

In an even further aspect of the invention, a method is provided for upgrading an ice cream production apparatus, which method comprises the step of replacing one or more parts of an existing stick inserter of the ice cream production apparatus so that a stick inserter as described above is obtained.

In some cases, it is sufficient to replace some parts of an existing stick inserter to obtain a stick inserter according to the present invention, which will often be more cost efficient than replacing the complete stick inserter.

### FIGURES

In the following an exemplary embodiment of the invention is described in more detail with reference to the figures, of which

FIG. 1 is a perspective view of a stick inserter known from the art,

FIG. 2 is a perspective view of some parts of the stick inserter of FIG. 1,

FIG. 3 is a cross-sectional view of the stick inserter of FIG. 1,

FIG. 4 is a perspective view of a stick inserter according to an embodiment of the invention,

FIG. 5 is a perspective view of some parts of the stick inserter of FIG. 4,

FIG. 6 is a cross-sectional view of the stick inserter of FIG. 4,

FIG. 7 illustrates a first stage of operation of the stick inserter of FIG. 4,

FIG. 8 illustrates a second stage of operation of the stick inserter of FIG. 4, and

FIG. 9 illustrates a third stage of operation of the stick inserter of FIG. 4.

### DETAILED DESCRIPTION OF THE INVENTION

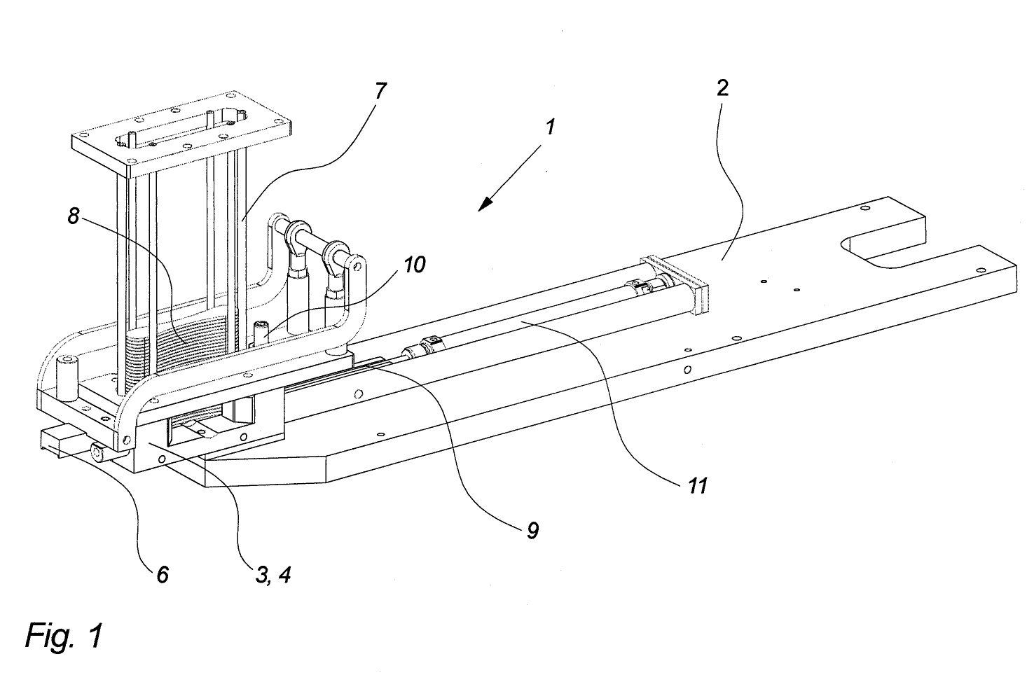

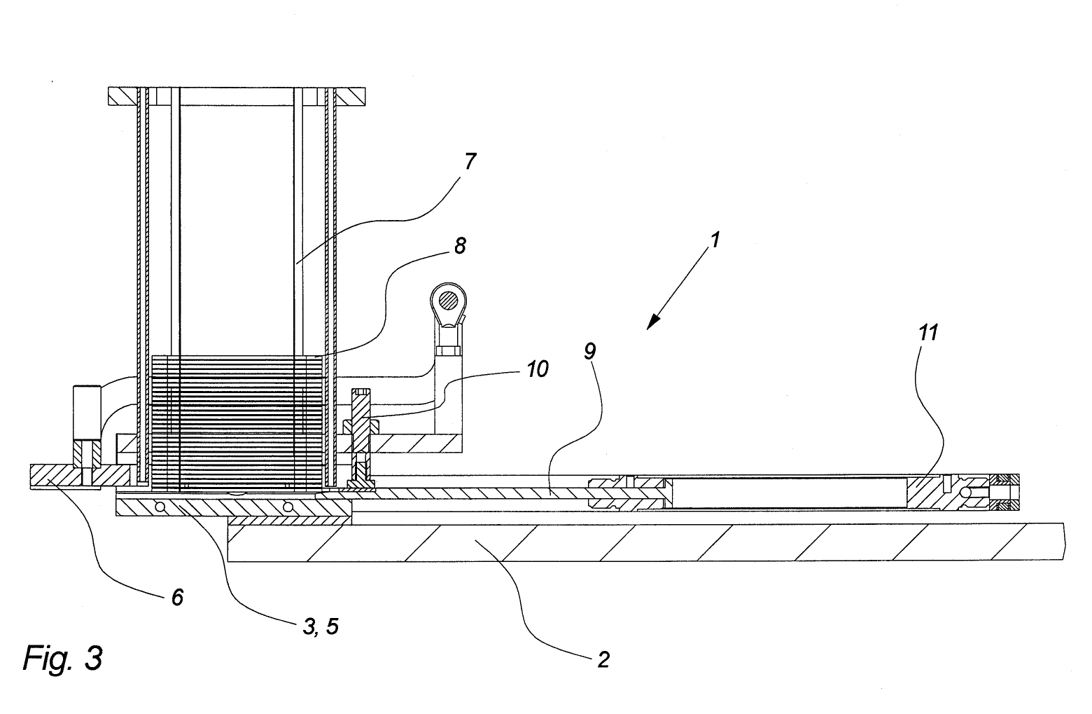

FIG. 1 is a perspective view of a stick inserter 1 known from the art and FIG. 3 is a cross-sectional view of the same stick inserter 1. The stick inserter 1 is mounted on a mounting plate 2 and consists essentially of three main parts, namely a pusher guide 3, a pusher plate 9 and a linear pneumatic actuator 11 driving a reciprocating motion of the pusher plate 9.

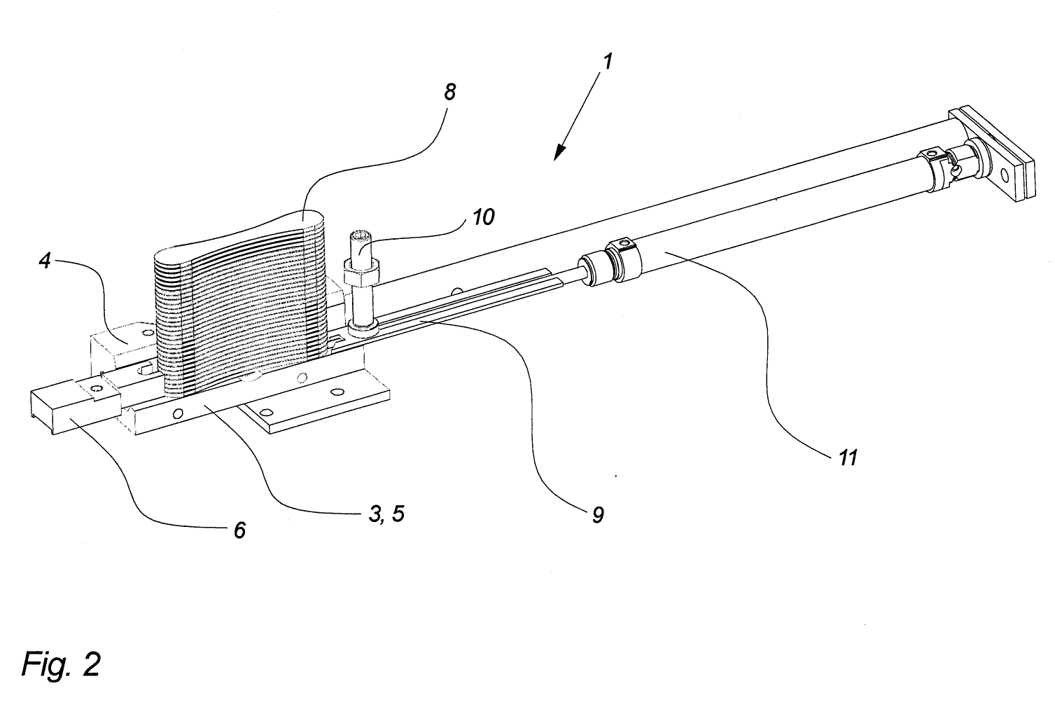

As can be seen more clearly from FIG. 2, which shows only some parts of the stick inserter 1 shown in FIG. 1, the basic construction of the pusher guide 3 consists of an elongated bottom piece 5, two side pieces 4 arranged on each side of the bottom piece 5, respectively, and a pusher nose 6 arranged on one end of the bottom piece 5.

An ice cream pile rack 7 of the pusher guide 3 holds a pile of ice cream sticks 8 resting on the bottom piece 5 between the two side pieces 4. When the lowermost ice cream stick 8 in the pile is pushed out of the pusher guide 3 by the pusher plate 5, its horizontal position and direction of motion is controlled and guided by the two side pieces 4, while its vertical position is controlled by the bottom piece 5 under the ice cream stick 8 and the pusher nose 6 over the ice cream stick 8.

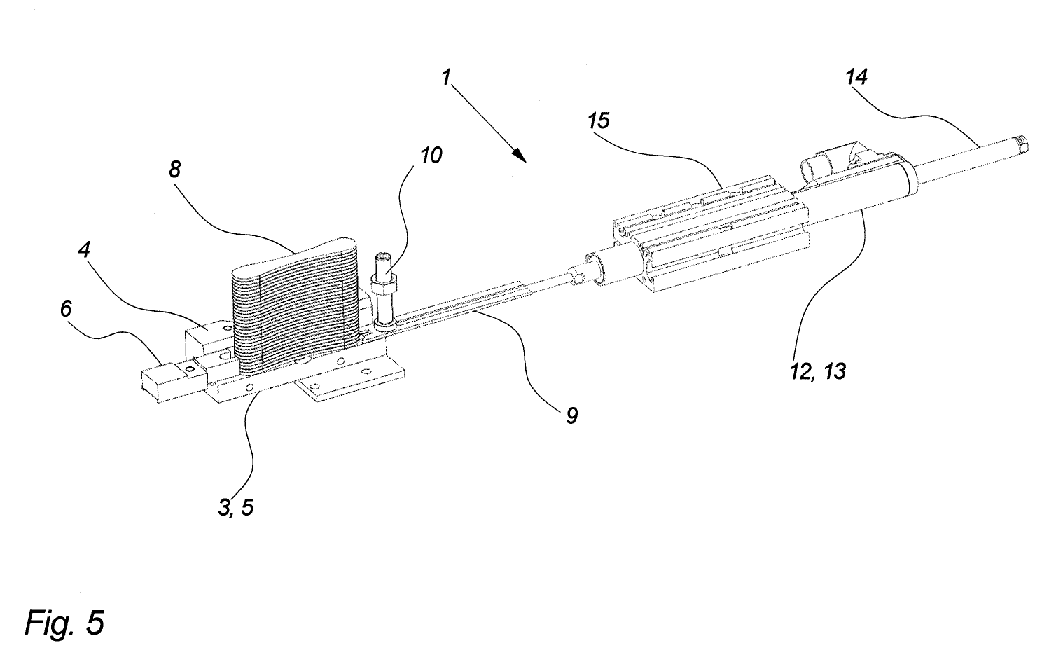

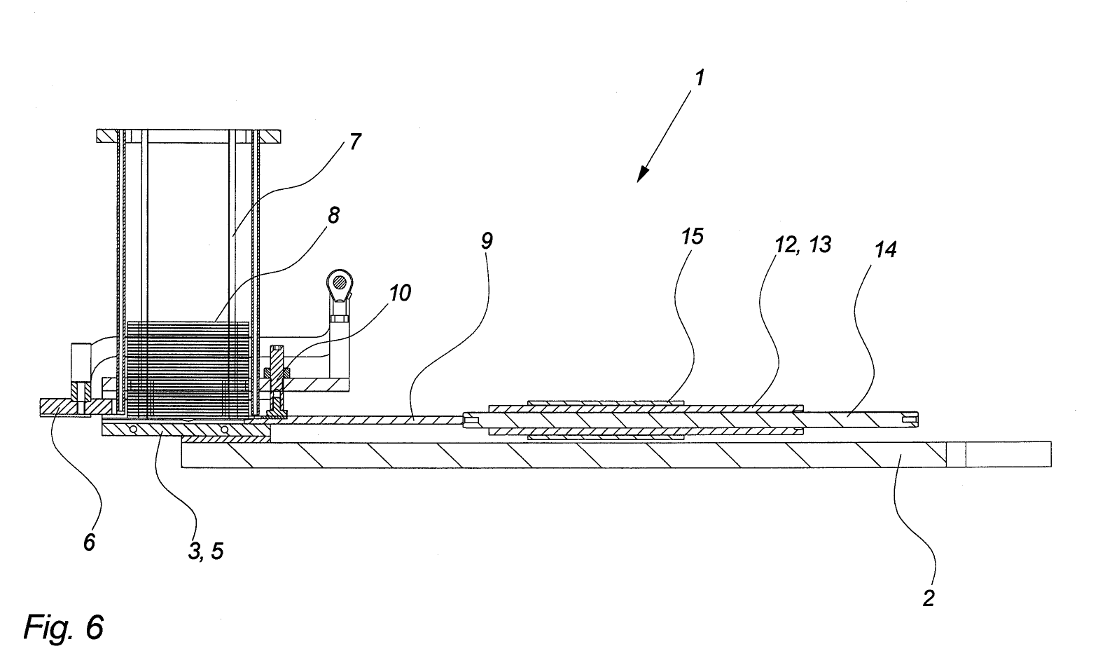

The reciprocating motion of the pusher plate 9 causes the insertion of ice cream sticks 8 from the pusher guide 3 into the ice cream mass 17 (not shown in FIGS. 1-6). On its forward stroke, the pusher plate 9 pushes the lowermost ice cream stick 8 in the pile out of the pusher guide 3. When the pusher plate 9 is retracted, the ice cream stick 8, which has now become the lowermost in the pile, is caused by gravity to fall down to the vertical level of the pusher plate 9, i.e. into position for being pushed out of the pusher guide 3 at the next forward stroke of the pusher plate 9.

The pusher plate 9 is held at the appropriate vertical position by the bottom piece 5 of the pusher guide 3 under the pusher plate 9 and a hold down 10 arranged over the pusher plate 9.

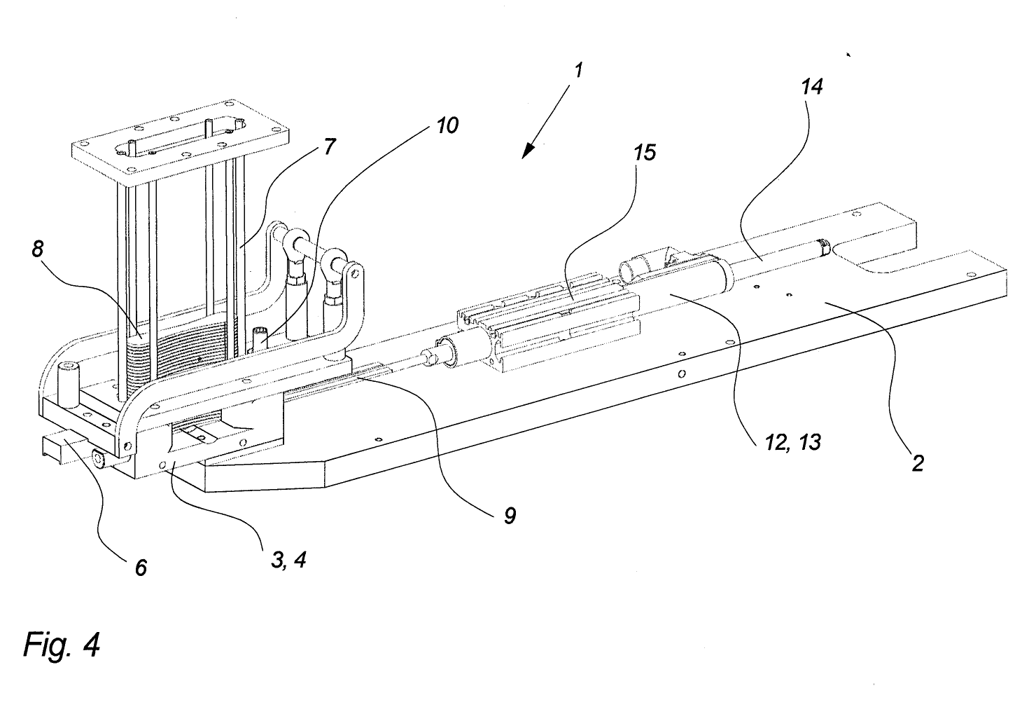

FIGS. 4-6 show a stick inserter 1 according to an embodiment of the invention. In many aspects, this stick inserter 1 is similar to the one shown in FIGS. 1-3.

The linear pneumatic actuator 11, however, has been replaced by a linear servo actuator 12, which basically consists of a servo body 13, a servo rod 14, which is rigidly connected to the pusher plate 9, and a cooling block 15. Alternating current through coils in the servo body 13 causes the servo rod 14, which contains a number of magnets, to move forth and back through the servo body 13 and, thereby, the pusher plate 9 to move forth and back in a reciprocating motion. The cooling block 15 is arranged around the servo body 13 to obtain the optimal cooling of the linear servo actuator 12.

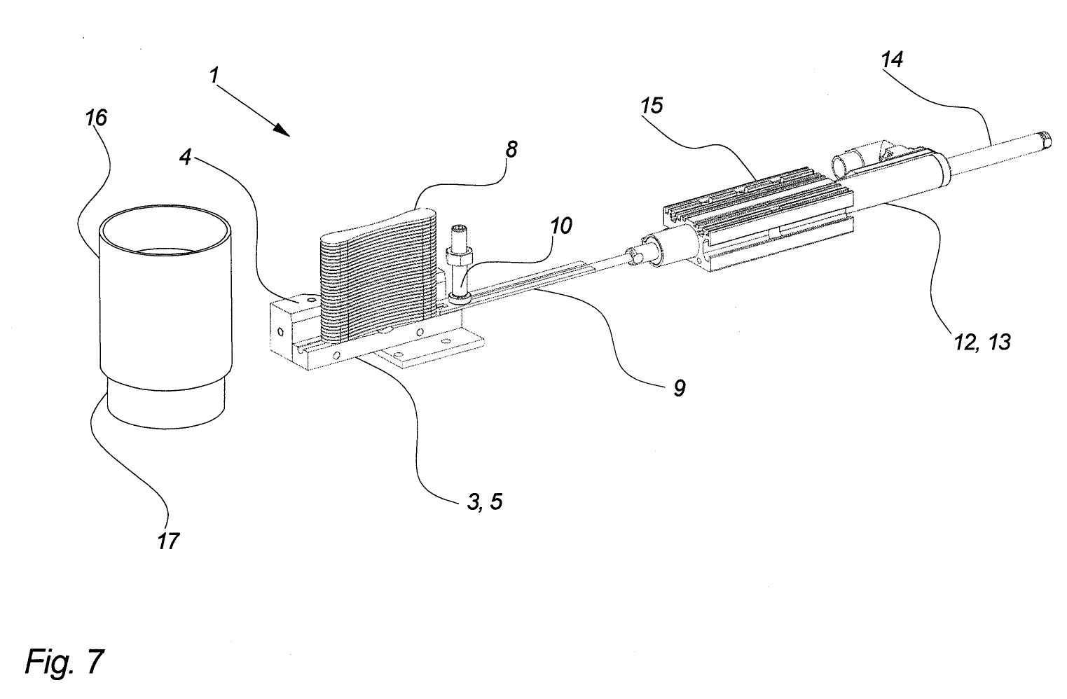

FIGS. 7-9 illustrate three stages of operation of the stick inserter 1 shown in FIGS. 4-6.

In FIG. 7, the pusher plate 9 is fully retracted, the tip of it resting on the bottom piece 5 of the pusher guide 3 and being held down by the hold down 10. In front of the pusher guide 3, an ice cream mass 17 is being extruded from an extruder tube 16 of an ice cream production apparatus.

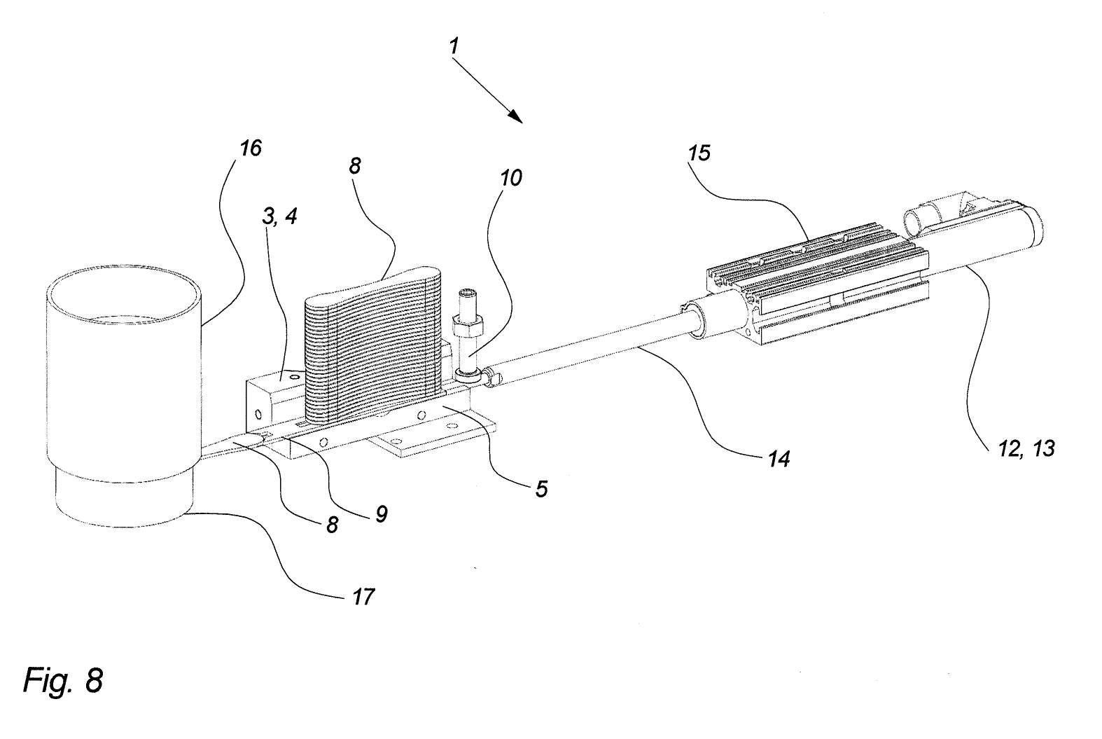

In FIG. 8, the pusher plate 9 has moved forward, pushing the lowermost ice cream stick 8 out of the pusher guide 3 and partly into the extruded ice cream mass 17 and taking the place of the ice cream stick 8 at the bottom of the pile.

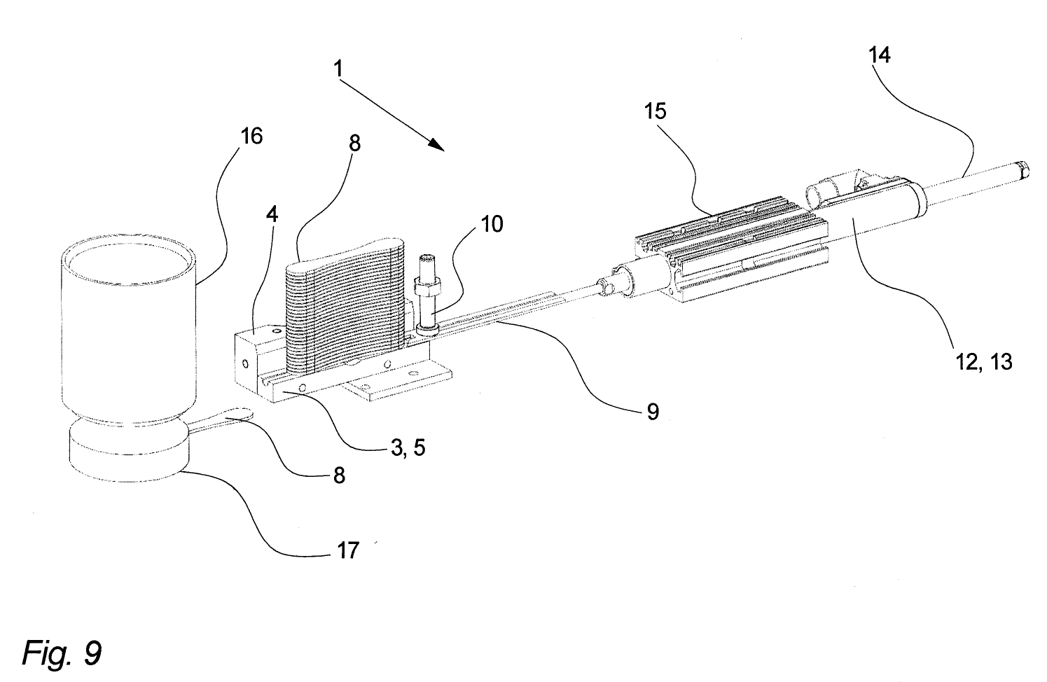

Finally, in FIG. 9, the pusher plate 9 is back in the fully retracted position and the next ice cream stick 8 is in position at the bottom of the pile for being pushed out of the pusher guide 3. The part of the extruded ice cream mass 17, into which the ice cream stick 8 was inserted in FIG. 8, has been cut off from the ice cream mass still within the extruder tube 16. Thus, an ice cream with a stick in it has been formed, which is ready to be packed or further processed.

### LIST OF REFERENCE NUMBERS

1. Stick inserter
2. Mounting plate for stick inserter
3. Pusher guide
4. Pusher guide side piece
5. Pusher guide bottom piece
6. Pusher nose
7. Ice cream pile rack
8. Ice cream stick
9. Pusher plate
10. Hold down for pusher plate
11. Linear pneumatic actuator
12. Linear servo actuator
13. Servo body
14. Servo rod
15. Cooling block
16. Extruder tube
17. Ice cream mass

1. A stick inserter for inserting ice cream sticks into frozen ice cream mass, said stick inserter comprising:
a pusher guide arranged to hold a pile of ice cream sticks and guide the motion of the ice cream sticks when they move from the pusher guide into the frozen ice cream mass,
a pusher plate arranged to reciprocate so that, when the pusher plate moves in a first direction, it pushes an ice cream stick of the pile out of the pusher guide, and when the pusher plate moves in the opposite, second direction, the next ice cream stick in the pile may move into position for being pushed out of the pusher guide, and
a linear actuator driving the reciprocating motion of the pusher plate, wherein the linear actuator is arranged to be driven by means of an alternating electromagnetic field.

2. A stick inserter according to claim 1, wherein the motion of the linear actuator is controlled using a servomechanism.

3. A stick inserter according to claim 1 or 2, wherein the linear actuator is arranged to be cooled by a cooling block arranged around the linear actuator.

4. A stick inserter according to claim 1, wherein the linear actuator is arranged to reciprocate between 200 and 600 times per minute, preferably between 300 and 400 times per minute.

5. A stick inserter according to claim 1, wherein the ice cream stick pushed out of the pile by the pusher plate is a lowermost ice cream stick in the pile.

6. A stick inserter according to claim 1, wherein the pile of ice cream sticks is arranged so that, when the pusher plate moves in the second direction, the next ice cream stick in the pile is caused to move into position for being pushed out of the pusher guide by gravity.

7. A stick inserter according to claim 1, which is arranged to be retrofitted in existing ice cream production apparatuses.

8. Use of a stick inserter according to claim 1 for inserting ice cream sticks into an ice cream mass being extruded from an ice cream production apparatus.

9. Use according to claim 8, wherein the temperature of the ice cream mass is between −10° C. and −1° C., preferably between −6° C. and −3° C.

10. Use of a stick inserter according to claim 1 for inserting ice cream sticks into an ice cream mass in a mould.

11. Method for inserting an ice cream stick into frozen ice cream mass, said method comprising:
moving a pusher plate from a loading position to an inserting position pushing the ice cream stick along a pusher guide into the ice cream mass, and
moving the pusher plate from the inserting position back to the loading position allowing another ice cream stick to be put in position for being inserted into the ice cream mass,
wherein the pusher plate is reciprocated by a linear actuator arranged to be driven by means of an alternating electromagnetic field.

12. Method for upgrading an ice cream production apparatus, which method comprises the step of retrofitting a stick inserter according to claim 1 in the ice cream production apparatus.

13. Method for upgrading an ice cream production apparatus, which method comprises the step of replacing one or more parts of an existing stick inserter of the ice cream production apparatus so that a stick inserter according to claim 1 is obtained.
